(19) United States
(12) Patent Application Publication
(10) Pub. No.: US 2002/0019780 A1
(43) Pub. Date: Feb. 14, 2002

(54) Just in time demand pull process and associated apparatus

(76) Inventor: David K. Herman, Fogelsville, PA (US)

Correspondence Address: DICKSTEIN SHAPIRO MORIN & OSHINSKY LLP, 2101 L STREET NW, WASHINGTON, DC, 20037-1526, US

(21) Appl. No.: 09/880,788

(22) Filed: Jun. 15, 2001

Related U.S. Application Data
(60) Provisional application No. 60/224,134, filed on Aug. 10, 2000.

(51) Int. Cl. G06F 17/60

(52) U.S. Cl. 705/26

(57) ABSTRACT

A system and associated method are provided for processing order information received from a customer. The method comprises a Just-In-Time demand pull process including generating a pull order from a customer's projected requirements, the pull order including a predicted quantity of end products and a predicted date on which the predicted quantity will be required by the customer. Sub-assemblies of the end product may be identified in the pull order that are capable of inclusion in a plurality of different end products, and production of the sub-assembly may be directed and tracked in addition to the end product. The seller delivers the end product in response to a standard order from the customer that includes a quantity required immediately by the customer and decrements the predicted quantity by the immediately required quantity.

This application claims priority from a U.S. provisional application with Ser. No. 60/224,134, filed Aug. 10, 2000, which is hereby incorporated by reference in its entirety.

### FIELD OF THE INVENTION

The present invention relates to manufacturing planning processes for use with manufacturing resource planning (MRP) systems, and more particularly to a manufacturing resource planning system using a Just-In-Time demand pull process.

### BACKGROUND OF THE INVENTION

Developers of manufacturing resource planning (MRP) systems are under constant pressure to increase the responsiveness and flexibility of their systems while reducing the amount of manual intervention required of an operator. One type of conventionally employed manufacturing resource planning system uses multiple system modules located at a seller to receive customer orders, coordinate and plan production of the ordered goods, and direct shipment of the goods to the customer in an expedited fashion.

For example, one system of this type is illustrated in FIG. 1. Referring to FIG. 1, the Leading Edge Procurement (LEP) system 10 enables a seller 18 to obtain customer requirements and deliver requested goods utilizing a weekly electronic forecast received from the customer 12. The customer 12 determines its own requirements using a manufacturing and resource planning (MRP) system 14 and sends to the seller 18 an electronic forecast in addition to its immediate requirements via an electronic data interchange (EDI) transmission 16. Based on this forecast of customer requirements, the seller 18 coordinates and plans production of requested goods using its planning systems, for example a leading edge procurement (LEP) Process module 22 and an Order Management and Planning (OMP) module 24 may be used to determine which resources are required to produce the customer requests and coordinate production with its Planning and Manufacturing Systems (PMS) 26. The Planning and Manufacturing Systems (PMS) may include, for example, a module located at a fabrication facility 34. The finished products may be received at a warehouse 36, where logistics 28 and inventory 32 modules may direct shipment of the finished products to the customer 12. Using the LEP system 10 enables the seller 18 to deliver a requested product closely tailored to the customer's real-time needs without the need for numerous orders to drive the manufacturing process.

The LEP system offers several advantages for doing business with the seller's major customers. The seller builds to the customer's forecast and ships the requested product based on the current week's requirement. Ideally, the forecast would match the ultimate shipping requirement and the seller would have produced the capacity required to meet all customer demand in the requested time frame. Unfortunately, a customer's forecasts are not always accurate, and as a result the seller may be surprised by customer requests that cannot timely be fulfilled with current capacity.

One approach 50 to resolving forecast inaccuracies involves creation and maintenance of a “blanket order,” as illustrated in FIG. 2. When a customer begins using the LEP system 10, a blanket order is created for a predetermined pricing period (usually one quarter or one year) for each product or product part to be tracked using the LEP system 10 (block 52). This blanket order is used for shipping, pricing, and contract purposes. The blanket order is usually updated weekly, based on the electronic forecast received from the customer (block 54).

The blanket order may be maintained by the seller in an LEP Order table (block 56). The LEP Order tables store information describing firm orders received by the seller. Using the LEP Process Module 22 (FIG. 1), the LEP Order tables may be adjusted to match the updates to the blanket order reflected in the electronic forecast received from the customer. For example, adjustments may be made to account for products in-transit that are not reflected in the electronic forecast, or for products sold only in packages of discrete quantities.

After the Order Management and Planning (OMP) module 24 (FIG. 1) receives the adjusted blanket order from the LEP Process Module 22, the blanket order is processed real-time via OMP planning logic (block 58) (FIG. 2). Recommended commit dates are thereby computed and capacity is soft-pegged for use in producing the requested product by the recommended commit dates (block 60). The seller's business planners may manually review, modify and approve the recommended commit dates (block 62). The Planning and Manufacturing Systems (PMS) are driven to produce sufficient inventory to satisfy the customer requirements by the approved dates (block 64). When the customer transmits a “shift signal” to the seller, indicating the customer's immediate desire to receive the requested products, the seller transmits the shift signal to the appropriate module (e.g., the logistics module 28) so that the products are shipped to the customer (block 66).

One problem with the “blanket order” approach 50 is that a customer may frequently adjust the blanket order quantity to reflect changes in anticipated demand. At the end of a pricing cycle, a new blanket order may be created to reflect price and demand changes. However, amendments to the blanket order require that the same process be followed as for a new blanket order, including changes to the LEP Order tables, forms to be filled out by the sales office, and coordinated activities across several departments within the seller's organization. Thus, on a weekly basis a cumbersome process of amending blanket orders must be accomplished, including numerous manual steps by system operators and business planners, for each adjustment to forecasted demand.

In addition, regional fluctuations in anticipated demand for a customer may necessitate changes in shipping procedures. For example, a customer anticipating increased demand in one location may seek to have a larger portion of its requested product delivered to that location. Although the total requested quantity has not changed, a new blanket order may be required to properly produce and deliver the requested product to the correct location.

Accordingly, there is a strong desire and need to develop a responsive, flexible system of manufacturing resource planning while reducing the amount of manual intervention required.

### SUMMARY OF THE INVENTION

A system and associated method for processing order information received from a customer is provided. In accordance with the invention, the method improves the responsiveness and flexibility of the manufacturing resource planning system while reducing the amount of manual intervention required of a system operator.

The method comprises a Just-In-Time demand pull process for receiving projected requirements from a customer, generating a pull order from the projected requirements including a predicted quantity of end products and a predicted date on which the predicted quantity will be required by the customer, identifying at least one sub-assembly included in the pull order capable of inclusion in a plurality of different end products, directing production of the predicted quantity including the sub-assembly, receiving at least one standard order from the customer including a quantity required immediately by the customer, decrementing the predicted quantity by the immediately required quantity, and directing delivery of the immediately required quantity to the customer.

In another aspect of the invention, the act of generating the pull order includes generating a Global Bill of Materials (BOM) for each sub-assembly of the pull order. Manufacturing yield and manufacturing interval are taken into account in generating the pull order, creating the Global BOM, and in further manufacturing and resource planning performed in the system of the present invention.

In another aspect of the invention, a standard order includes a plurality of delivery destinations, and the act of directing delivery includes directing a subset of the immediately required quantity to each of the delivery destinations.

In another aspect of the invention, an account of the customer is debited according to up-to-date pricing information associated with the immediately required quantity.

### BRIEF DESCRIPTION OF THE DRAWINGS

The foregoing and other features and advantages of the invention will become more apparent from the detailed description of the exemplary embodiments of the invention given below with reference to the accompanying drawings in which:

FIG. 1 illustrates a conventional system configuration including modules of a customer manufacturing resource planning (MRP) system interfacing with a seller leading edge procurement (LEP) system;

FIG. 2 illustrates a block diagram for a conventional blanket order method;

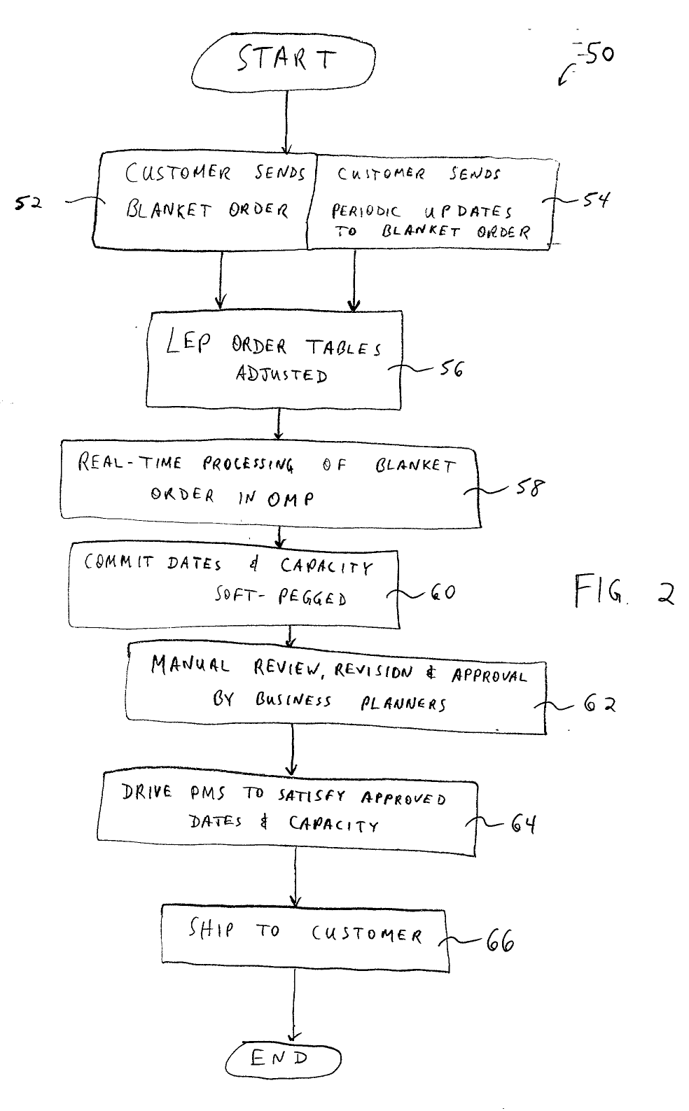

FIG. 3 illustrates a block diagram for a Just-In-Time manufacturing method utilizing pull orders in accordance with an exemplary embodiment of the invention;

FIG. 4 illustrates a processor system formed in accordance with another exemplary embodiment of the invention; and

FIG. 5 illustrates a network system formed in accordance with another exemplary embodiment of the invention.

### DETAILED DESCRIPTION OF THE INVENTION

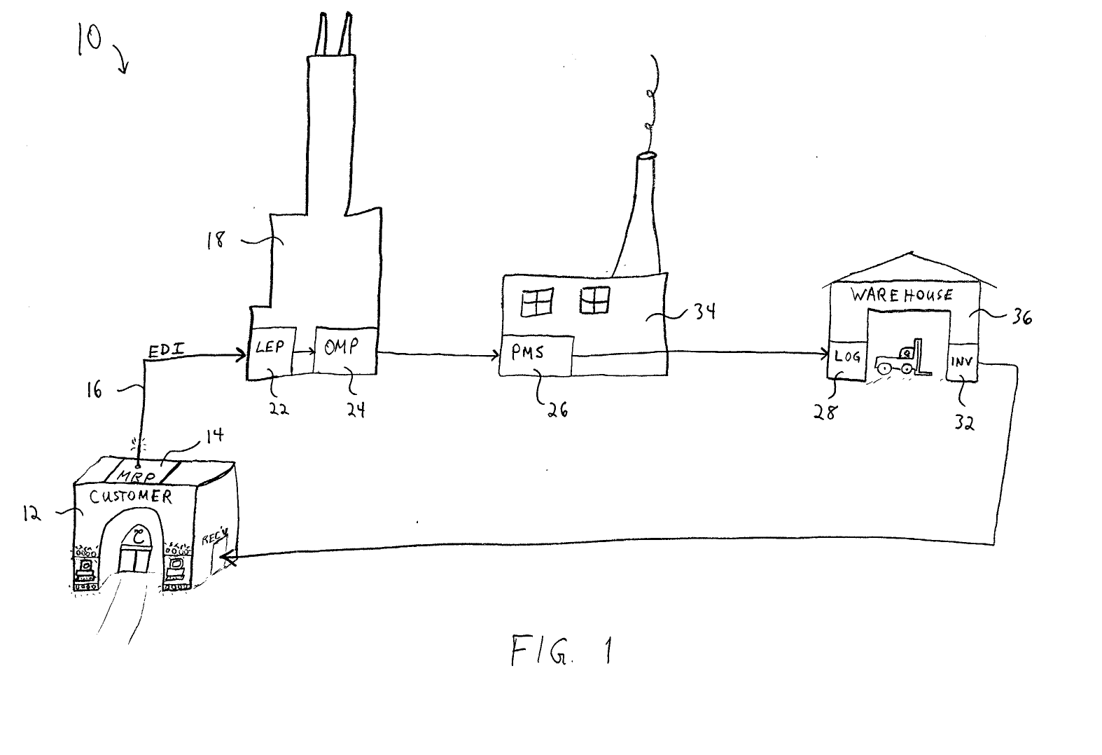

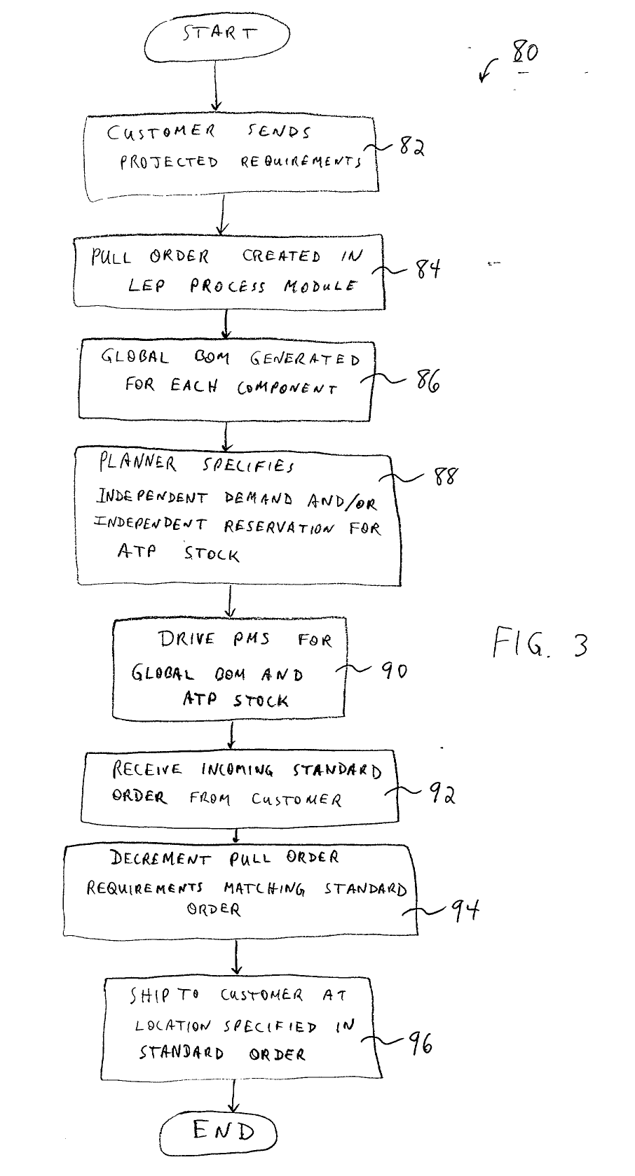

Exemplary embodiments of the invention will now be described with reference to FIGS. 3-5. FIG. 3 illustrates a block diagram for a Just-In-Time manufacturing resource planning (MRP) method 80 utilizing pull orders in accordance with an exemplary embodiment of the invention. Referring to FIG. 3, a seller utilizing the method 80 may receive a customer's “projected requirements” (block 82). The projected requirements may be sent in the form of an EDI transmission 16 (FIG. 1), or using other methods of data communications well known in the art, for example a spreadsheet may be transmitted via the Internet, customer requirements may be communicated via a telephone call or personal conference, etc. The projected requirements received from the customer are generated by the customer's manufacturing resource planning (MRP) systems and typically include specified quantities of manufactured products, or parts, desired by the customer on specific dates. The customer's projected requirements may be used to create a ‘pull order’ in the LEP Process module 22 (block 84).

A pull order is a prediction created in the LEP Process module 22 (FIG. 1) including a predicted quantity of end products and a predicted date on which the predicted quantity will be required by the customer. The predictions in the pull order may be generated using a variety of different types of information, for example the currently projected requirements, historical accuracy of the customer projections, seasonal demand fluctuations, and other information types known in the art. The pull order may be sent to the seller's Order Management and Planning (OMP) 24 and Planning and Manufacturing Systems (PMS) 26 modules for coordination throughout the manufacturing process. In one embodiment, for tracking purposes the pull order may be identified by a unique combination of customer number, customer part number, and seller part number.

As noted, the projected requirements typically include a number of manufactured products, or parts, desired by the customer. To facilitate production of the parts desired by the customer, a Global Bill of Materials (BOM) may be generated corresponding to the pull order (block 86). In addition, a Global BOM may be generated for several components of the products which are identified by the LEP Process module 22 as an Independent Demand part. For example, a sub-assembly that may be converted into several different end products may be identified as an Independent Demand part. By establishing a sub-assembly as an Independent Demand part, the system automatically generates a Global BOM for that component, permitting its production to be tracked and driven via the Planning and Manufacturing Systems (PMS) module 26.

This ability to identify sub-assemblies may significantly improve flexibility and efficiency, for example when the projected requirements of a plurality of customers includes differing end products, but includes common sub-assemblies. Identification of a common sub-assembly may permit the production of the sub-assembly to be more closely monitored during manufacturing, with consequent gains in manufacturing yield and efficiency.

The LEP Process module 22 may automatically convert the customer's projected requirements taking manufacturing yield and manufacturing interval into account. For example, if the yield from a component to the completed end product is 80%, the manufacturing interval is 7 days, and the customer's projected requirements include a request for 16 sub-assemblies due 14 days from today, then a ‘PULL’ order may be generated for the component including 20 sub-assemblies with a request date of 7 days from today.

The method 80 also includes options for enhancing management flexibility of the production process. For example, if a business planner for the seller wants to build additional product to protect against the customer revising his forecast at the last minute, the planner may use the Independent Demand feature to specify a fixed quantity of a specific end item or component to be produced (block 88). Also, if the planner wants to reserve buffer stock for a specific customer, then the Independent Demand Reservation feature may be used (block 88). The LEP Process module 22 may automatically calculate the desired reservation quantity based on planner entered criteria. When inventory falls below the desired Independent Demand level for a component, additional resources may be allocated toward production of that component. The buffer stock is available as Available To Promise (ATP) inventory for order processing. If the buffer stock is held for a specific customer (e.g., Independent Demand Reservation), then only orders from that customer could use that specific buffer stock for order scheduling.

When created, the pull order is not placed on the LEP Order tables but instead is placed on an LEP Requirement table, reflecting the customer demand sent to the seller from the customer's MRP systems. The LEP Requirements tables differ from the LEP Order tables in that the LEP Requirements tables represent expected, but not firm, order received by the seller. However, in accordance with the invention the seller may process the customer projected requirements like firm orders and schedule their completion according to the predicted date in the pull order. The seller may match these requirements to the available supply while considering capacity constraints, e.g., in the Order Management and Planning (OMP) module 24, and drive production, e.g., using the Planning and Manufacturing Systems (PMS) module, of the requested end product or a sub-assembly if the customer demand is more effectively predicted in terms of the sub-assembly (block 90).

As noted, in the prior process many cumbersome tasks were associated with maintenance of a blanket order. Elimination of the blanket order may permit significantly less manual intervention for the seller and the customer. In an exemplary process of the present invention, the customer places a new ‘STANDARD’ or ‘CONSIGNMENT’ order with the seller when the customer is ready to receive the product (block 92). The customer may specify a quantity immediately required and multiple ship-to destinations. Like the customer projected requirements, the standard order may be transmitted via EDI, the Internet, telephone, personal conference, etc. If the customer's previously projected requirements accurately predicted current demand, then the immediately required quantity may be available for immediate shipment to the customer.

The seller matches incoming ‘STANDARD’ or ‘CONSIGNMENT’ order types to ‘PULL’ order requirements by matching on customer number, customer part number, and seller part number. The seller uses the inventory and capacity held by the matching ‘PULL’ order for the new incoming standard order and decrements the ‘PULL’ order by the amount of the matching standard order in the time frame that it is required by the customer (block 94). The ‘PULL’ order is decremented to avoid doubling the customer's order demand. As a result, the seller's business planners do not need to approve the commit dates and soft-pegged capacity, as they did with the previous blanket order process, because it is not necessary for them to revise the entire blanket order, for example for shipping purposes, pricing updates, etc. By only requiring that a ‘STANDARD’ or ‘CONSIGNMENT’ order be placed, the seller may provide the customer with the needed flexibility of only placing an order when the product is required, e.g., a Just-In-Time (JIT) process.

The incoming standard order may be automatically accepted and scheduled if inventory supports the customer's request date and the immediately required quantity may be shipped to the customer from the warehouse 36 (block 96). If not, additional production may be scheduled via the Independent Demand and/or Independent Demand Reservation feature (block 88). This feature permits enhanced production flexibility without the cumbersome manual tasks required for maintenance of an entire blanket order.

In addition, the customer may specify multiple ship-to locations where they want sub-quantities of the immediately required quantity shipped. The method 80 permits multiple ship-to destinations without maintenance of a blanket order or requiring that the customer maintain a central shipping location where the customer must separate the shipment, re-package, and ship to final destinations.

Also, because pricing may be negotiated independently of transmissions received from the customer, the logistics module 28 may be configured to automatically retrieve the current correct pricing information for that customer and debit an account of the customer accordingly when the product is shipped from the warehouse 36. Pricing information may be entered, e.g., via the Order Management and Planning (OMP) module 24, by sales or planning personnel of the seller, or may be negotiated online via the Internet using various online facilities known in the art.

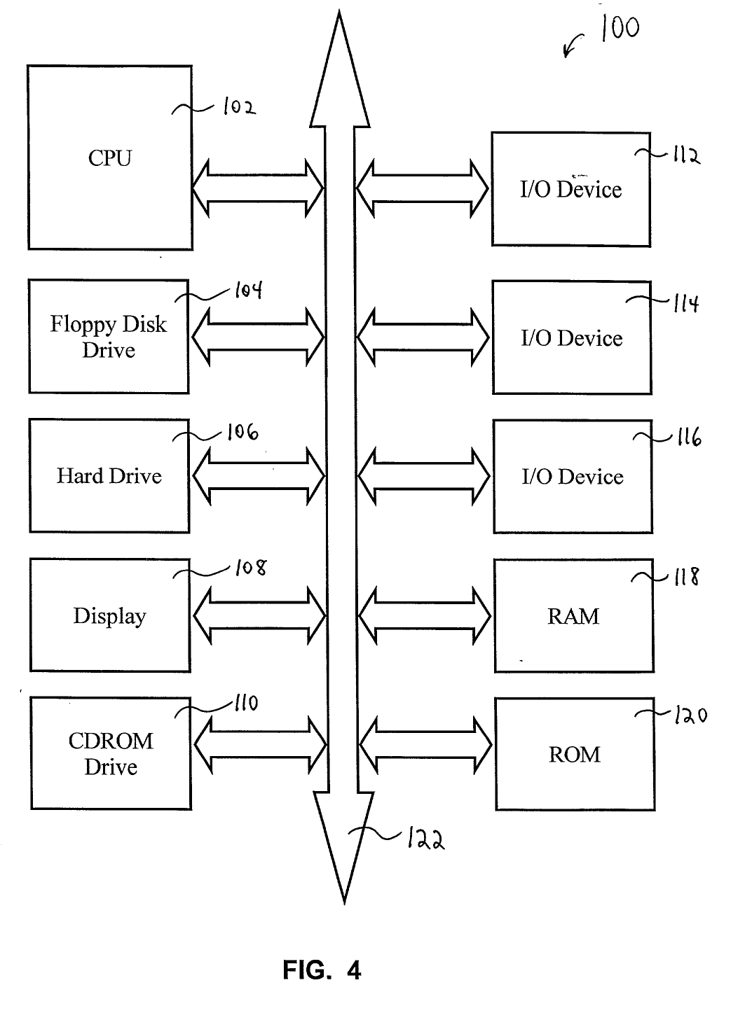

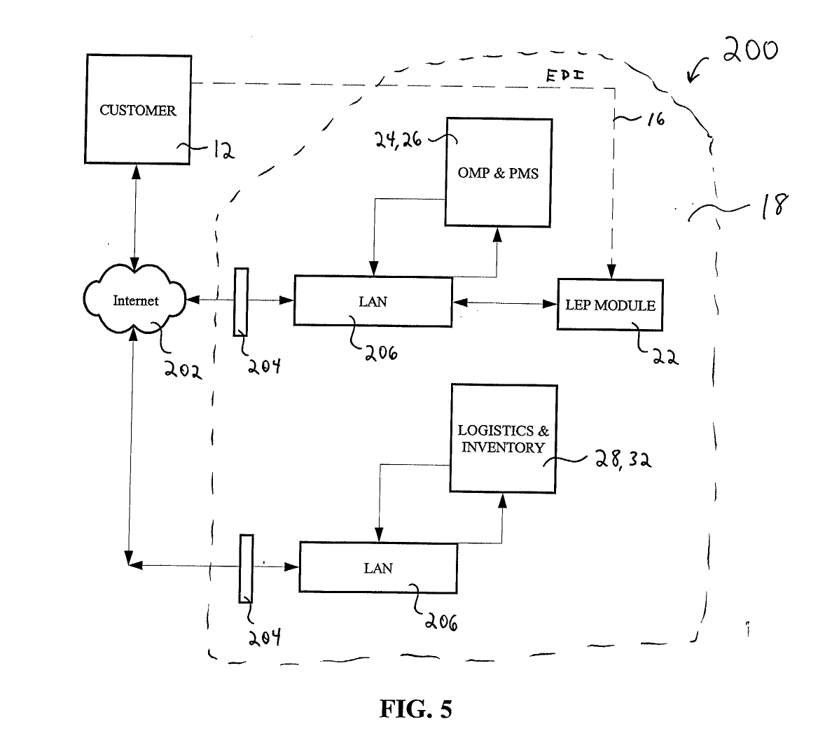

FIGS. 4 and 5 illustrate exemplary systems for implementing the Just-In-Time Demand pull process in accordance with the present invention. FIG. 4 illustrates an exemplary processor system 100 which may be used to implement one or more modules of the Just-In-Time Demand Pull process. Referring to FIG. 11, the processor system 100, which may be a computer system, for example, generally comprises a central processing unit (CPU) 102, for example, a microprocessor, that communicates with one or more input/output (I/O) devices 112, 114, 116 over a system bus 122. The computer system 100 also includes random access memory (RAM) 118, a read only memory (ROM) 120 and, in the case of a computer system may include peripheral devices such as a floppy disk drive 104, a hard drive 106, a display 108 and a compact disk (CD) ROM drive 110 which also communicate with the processor 102 over the bus 122. The RAM 118 includes memory devices storing processing programs comprising at least one of the modules 22, 24, 26, 28, 32 used in the Just-In-Time Demand pull process in accordance with the invention. One or more of the I/O devices 112, 114, 116 may be used to communicate with at least one other module 22, 24, 26, 28, 32 in accordance with the invention and as illustrated in FIG. 1. In addition, the MRP system 14 on the customer side may also be implemented using a computer system 100 and may also communicate via one or more I/O devices 112, 114, 116 with seller modules 22, 24, 26, 28, 32 in accordance with the invention. It should also be noted that FIG. 4 is merely representative of many different types of system architectures which may employ the invention.

For example, FIG. 5 shows another exemplary embodiment including a network system 200 implementing the Just-In-Time Demand pull process in accordance with the invention. The customer 12 is coupled to the seller 18 via one or more network connections, e.g., the Internet 202. The customer 12 may transmit projected requirements and/or standard orders to the LEP Process module 22 of the seller via the Internet 202 and/or via an EDI transmission 16. The LEP Process module 22 may communicate with other modules, e.g., the Order Management and Planning (OMP) 24, Planning and Manufacturing Systems (PMS) 26, logistics 28 and inventory 32 modules, located at local or remote seller sites via a Local Area Network (LAN) 206 at each seller site. Each site may also include a firewall 204 between the Internet 202 and each of Seller's LANS 206 to provide network security. In this way, the Internet 202 may be used to route communications to the proper destination module 22,24, 26, 28, 32.

In accordance with the invention, a system and associated method are provided for processing order information received from a customer. The method comprises a Just-In-Time demand pull process including generating a pull order from a customer's projected requirements, the pull order including a predicted quantity of end products and a predicted date on which the predicted quantity will be required by the customer. Sub-assemblies of the end product may be identified in the pull order that are capable of inclusion in a plurality of different end products, and production of the sub-assembly may be directed and tracked in addition to the end product. The seller may then deliver the end product in response to a standard order from the customer that includes a quantity required immediately by the customer. In this way, the present method improves the responsiveness and flexibility of the manufacturing resource planning system while reducing the amount of manual intervention required of a system operator.

While the invention has been described and illustrated with reference to specific exemplary embodiments, it should be understood that many modifications and substitutions can be made without departing from the spirit and scope of the invention. Accordingly, the invention is not to be considered as limited by the foregoing description but is only limited by the scope of the appended claims.

What is claimed as new and desired to be protected by Letters Patent of the United States is:

1. A method of processing order information from a customer, comprising:
receiving at least one projected requirement from a customer, said projected requirement including a projected quantity and a projected date on which said projected quantity will be required by said customer;
generating a pull order using said at least one projected requirement, said pull order including a predicted quantity of end products and a predicted date on which said predicted quantity will be required by said customer;
directing production of said predicted quantity;
receiving at least one standard order from said customer, said standard order including a quantity required immediately by said customer;
decrementing said predicted quantity by said immediately required quantity; and
directing delivery of said immediately required quantity to said customer.

2. A method as in claim 1, wherein said at least one standard order includes a plurality of delivery destinations, and said act of directing delivery includes directing a subset of said immediately required quantity to each of said delivery destinations.

3. A method as in claim 1, further comprising debiting an account of said customer according to a current price of said immediately required quantity.

4. A method as in claim 3, wherein said account is debited when said immediately required quantity is shipped to said customer.

5. A method as in claim 1, wherein said at least one projected requirement is received via the Internet.

6. A method as in claim 1, wherein said at least one standard order is received via the Internet.

7. A method as in claim 1, wherein when said immediately required quantity is available for immediate delivery, said act of directing delivery is performed immediately and without operator intervention.

8. A method as in claim 1, wherein when said immediately required quantity is not available for immediate delivery, said act of directing delivery is performed immediately and without operator intervention as to an immediately available subset of said immediately required quantity, production is directed of a remainder of said immediately required quantity, and said act of directing delivery is performed at a later time for said remainder of said immediately required quantity.

9. A method as in claim 1, further comprising directing production of an additional quantity in addition to said predicted quantity to protect against last minute revisions of said projected requirements of said customer.

10. A method as in claim 9, further comprising reserving said additional quantity for delivery only to said customer.

11. A method as in claim 1, further comprising identifying at least one subassembly included in said pull order capable of inclusion in a plurality of different end products.

12. A method as in claim 11, wherein said act of generating said pull order includes generating a Global Bill of Materials (BOM) for each said at least one subassembly of said pull order.

13. A method as in claim 12, wherein said act of generating said Global Bill of Materials (BOM) includes taking manufacturing yield and manufacturing interval into account.

14. A system for processing order information from a customer, comprising:
a receiver module for receiving at least one projected requirement from a customer and receiving at least one standard order from said customer, said projected requirement including a projected quantity and a projected date on which said projected quantity will be required by said customer and said standard order including a quantity required immediately by said customer;
a process module for generating a pull order using said at least one projected requirement, said pull order including a predicted quantity of end products and a predicted date on which said predicted quantity will be required by said customer;
a planning and manufacturing module for directing production of said predicted quantity;
an order management and planning module for decrementing said predicted quantity by said immediately required quantity; and
a logistics module for directing delivery of said immediately required quantity to said customer.

15. A system as in claim 14, wherein said process module is configured to identify at least one sub-assembly included in said pull order capable of inclusion in a plurality of different end products.

16. A system as in claim 14, wherein said at least one standard order includes a plurality of delivery destinations, and said logistics module directs delivery of a subset of said immediately required quantity to each of said delivery destinations.

17. A system as in claim 14, wherein said order management and planning module debits an account of said customer according to a current price of said immediately required quantity.

18. A system as in claim 14, wherein said receiver module is coupled to receive data via an electronic data interchange (EDI) system.

19. A system as in claim 14, wherein said receiver module is configured to receive data from a manufacturing and resource planning (MRP) system of said customer.

20. A system for processing order information from a customer, comprising:
a plurality of modules configured for processing said order information, said plurality of modules running on one or more processors and comprising:
a receiver module for receiving at least one projected requirement from a customer and receiving at least one standard order from said customer, said projected requirement including a projected quantity and a projected date on which said projected quantity will be required by said customer and said standard order including a quantity required immediately by said customer;
a process module for generating a pull order using said at least one projected requirement, said pull order including a predicted quantity of end products and a predicted date on which said predicted quantity will be required by said customer, said process module identifying at least one sub-assembly included in said pull order capable of inclusion in a plurality of different end products;
a planning and manufacturing module for directing production of said predicted quantity, including said at least one sub-assembly;
an order management and planning module for decrementing said predicted quantity by said immediately required quantity; and
a logistics module for directing delivery of said immediately required quantity to said customer.
